(19) United States
(12) Patent Application Publication
(10) Pub. No.: US 2016/0203926 A1
(43) Pub. Date: Jul. 14, 2016

(54) Switching Device with Improved Tripping Action in the Event of a Short Circuit

(71) Applicant: SIEMENS AKTIENGESELLSCHAFT, München (DE)

(72) Inventor: Martin STEINBAUER, Schmidmühlen (DE)

(21) Appl. No.: 14/914,521

(22) PCT Filed: Sep. 13, 2013
(86) PCT No.: PCT/EP2013/068981

§ 371 Date: Feb. 25, 2016

(51) Int. Cl. H01H 33/02

(52) U.S. Cl. CPC H01H 33/02

(57) ABSTRACT

A switching device having an arc quenching chamber, a fixed contact element and a movable contact element movable in a sliding contact between untripped and tripped positions within the chamber. A plurality of centering structures are arranged on the walls of the arc quenching chamber for centered guiding movement of the movable contact element as it moves from its untripped position to its tripped position. The centering structures may be fabricated unitarily with the chamber walls, as of plastic, and are arranged in parallel and spaced apart relation to one another.

The invention relates to a switching device with an arc quenching chamber in which a contact arrangement consisting of a fixed and a moving contact element is arranged, wherein the moving contact element is guided in a sliding contact.

Switching devices, in particular power switches, are used amongst other purposes for switching off safely in the event of a short circuit, in that way protecting loads and installations. Electrical or mechanical switching devices are furthermore suitable for operationally correct manual switching of loads and for safe disconnection of an installation from the power grid during servicing work or modifications to the installation. Electrical switching units are often operated electromagnetically.

This means that switching units of this type are highly technical electrical switching devices with integrated protection for motors, cables, transformers and generators. They find their application at functional locations with low switching frequency. In addition to short-circuit protection, switching units of this type are also suitable for overload protection.

In the event of a short circuit, an electrical switching unit switches an electrical installation off safely. It thus offers fuse protection against overload. Any cable through which the current flows heats up more or less strongly. The heating here depends on the ratio of the current magnitude to the cross-sectional area of the conductive cable, what is known as the current density. The current density must not be too large, since otherwise the cable insulation may become charred, or it is possible that a fire may break out, as a result of the excessive heat. In order to protect electrical installations against these damaging effects, switching units are used as overcurrent protection devices.

Power switches comprise two independently acting trip mechanisms for the overload protection and the short-circuit protection. The two trips are connected in series. The protection against short circuit is effected by an electromagnetic trip that operates with almost no time delay. In the event of a short circuit, the electromagnetic trip unlatches a switch lock of the power switch without delay. A switch armature disconnects the contact element before the short-circuit current can reach its maximum value.

Known switching units comprise a sliding contact unit with a sliding contact and a moving contact element. The moving contact element furthermore comprises electrical contacts. Switching units of this type furthermore comprise first contacts to an electric cable. In a switched-on state, the electrical contacts of the movable contact element contact the fixed contacts of the switching unit. In the event of a short circuit, the electrical contacts of the movable contact element are released from the fixed contacts, so that the flow of current is interrupted. The movable contact element is here released from the fixed contacts.

Known sliding contacts of switching units frequently comprise two guidance systems, an inner and an outer guidance system. The outer guidance system is used when the switching procedure, in other words switching on or switching off, is made by means of a switch lock of the switching unit. In this case, no bridge rotator occurs. The inner guidance system is used in the event of a short circuit, when the switching procedure is effected by a switching armature, frequently a plunger in combination with a guidance pin, of the switching unit. This means that, when switching off as a result of a short circuit, the movable contact element moves quickly along the inner guidance system in front of the sliding contact, strikes impact surfaces in what is known as the lower part of the switching unit, and flies back again along the inner guidance system. It flies here against the switching armature or the guidance pin of the switching unit.

If heavy short circuits occur, large magnetic forces in turn develop between the movable contact element and the fixed contact elements. These are, in part, the current loop forces between the fixed contact elements and the bridge. These are also large current magnitude forces between the silver contacts. The effect of these two forces is that in the event of a short circuit, the bridge is thrown suddenly against its resulting spring force and strikes against the impact dome in the lower part. Since it is not possible for the impact dome to be positioned in the center of the switching chamber as this location is required by the guide plate, it was divided and is now located against the chamber walls. It is true that the bridge is secured against rotating by a guide pin, but its guide play can not, however, be sufficiently limited here. If the bridge now makes use of the degrees of freedom it has due to its construction, it can happen that it only meets the impact dome on one side, and then gets wedged in the lower part.

A further problem consists in that when certain switching activities are carried out at switching devices, in particular at power switches, extreme heating of the switch contact occurs. In particular in the case of a changing to the off position after a period of being switched on, the very hot contact bridge can damage the surrounding areas of the housing of the switch chamber, which usually consist of plastic. This mainly occurs in the off position since in this case the thermal losses arising in the bridge cannot flow away into the fixed contact elements, and when in the off position the bridge is in a position that is almost thermally insulated on every side. Since the bridge has to have a freely movable implementation, it has a certain rotary play in the axial direction of the sliding contact to the switching chamber wall. Under unfavorable conditions, the bridge uses its rotary play and becomes located too close to the plastic wall of the switching chamber. As a result of the hot bridge, the plastic swells, surrounds the bridge, as a result of which the power switch is destroyed.

On this basis, the object of the present invention is to provide a switching device that overcomes the problems described above.

This object is achieved according to the invention by a switching device with the characteristics of claim 1. Further exemplary embodiments of the invention emerge from the dependent claims, the description, and the drawing.

According to the invention this object is achieved by a switching device with an arc quenching chamber in which a contact arrangement of a fixed and a movable contact element is arranged, wherein the movable contact element is guided in a sliding contact. The invention is characterized in that the movable contact element is guided when tripped by centering structures on the housing walls of the arc quenching chamber.

The problems described above are overcome by the centering structures according to the invention, which are injection-molded together with the lower part walls of the switching chamber of the power switch. When the bridge is thrown downwards by the loop and current magnitude forces, it is aligned by the centering structures, and strikes the center of both impact domes. An off-center impact is thus no longer possible, and the bridge cannot become twisted.

A further advantage consists in that through the centering structures the bridge is centrally aligned at the bottom reversal point of the movement. When in its off position, the bridge is thus located relatively accurately in the center of the switching chamber, as a result of which it is sufficiently distant from the two switching chamber walls. In spite of the raised temperature that it can develop after many switching processes, it is at a sufficient distance from the plastic wall to ensure that the bridge does not become burnt into the lower part.

In one particularly advantageous embodiment of the invention it can be provided that the centering structures are fabricated as one piece with the housing walls of the arc quenching chamber. This means that the centering structures are formed together with the housing walls of the arc quenching chamber in one process step using an injection technique. As a result it is not necessary to manufacture an additional part, but it is only necessary for the housing walls of the arc quenching chamber to be specially shaped.

According to a further exemplary embodiment of the invention, it can be provided that the centering structures are made of plastic. As a result of this it is possible for the centering structures to be manufactured together with the housing walls of the arc quenching chamber in one process step in the form of an injection-molding process.

In a particularly advantageous embodiment of the present invention it can be provided that a second set of centering structures is arranged on a second housing wall of the arc quenching chamber located opposite to the first set of centering structures on a first housing wall of the arc quenching chamber, so that the movable contact element is positioned between two sets of centering structures. This arrangement according to the invention also contributes to uniform guidance of the movable contact element.

In addition it can furthermore be provided that the centering structures are arranged to the side next to the sliding contact, so that when tripped the movable contact element is guided reliably.

The fact that the switching device is preferably a power switch also corresponds to the invention.

The switching device according to the invention comprises an arc quenching chamber in which a sliding contact is arranged, in which a movable contact element is guided. To the side, next to the movable contact element, on both the right and the left, arc quenching baffle packages are arranged comprised of arc quenching baffles arranged in parallel over one another.

On a housing wall of the arc quenching chamber, in the region of the movable contact element, centering structures according to the invention are arranged. These centering structures are preferably fabricated as one piece with the housing wall of the arc quenching chamber, meaning that the centering structures are not formed as an additional part on the housing wall, but are injection-molded together with the housing wall within one process step. For that reason the centering structures are preferably also made of plastic.

Preferably the centering structures according to the invention are arranged parallel to one another on the housing wall of the arc quenching chamber, and are spaced apart from one another. Preferably set a second set of centering structures is arranged on a second housing wall of the arc quenching chamber located opposite to a first set of centering structures on a first housing wall of the arc quenching chamber, so that the movable contact element is positioned between two sets of centering structures.

The centering structures according to the invention are preferably arranged next to the sliding contact, i.e. to the right and left of the sliding contact.

The switching device presented here, in particular the power switch with high switching capacity is characterized in that less room is available for the bridge guidance in order to align the bridge always in the center of the chamber. Due to the increased forces that throw the bridge in the event of a short circuit, and as a result of a potentially non-central position of the bridge, the bridge can become jammed in the lower part, as a result of which the device can no longer be switched on. Through the centering structures according to the invention presented here, the bridge always meets the impact dome symmetrically, and jamming is avoided. A further result is that due to the centering structures according to the invention, the bridge is aligned centrally during the course of its movement, as a result of which it always exhibits an adequate distance from the chamber walls when in the off position. Melting within the switching chamber is thus prevented.

Further advantages and embodiments of the invention are explained below with reference to an exemplary embodiment and with reference to the drawing.

Here:

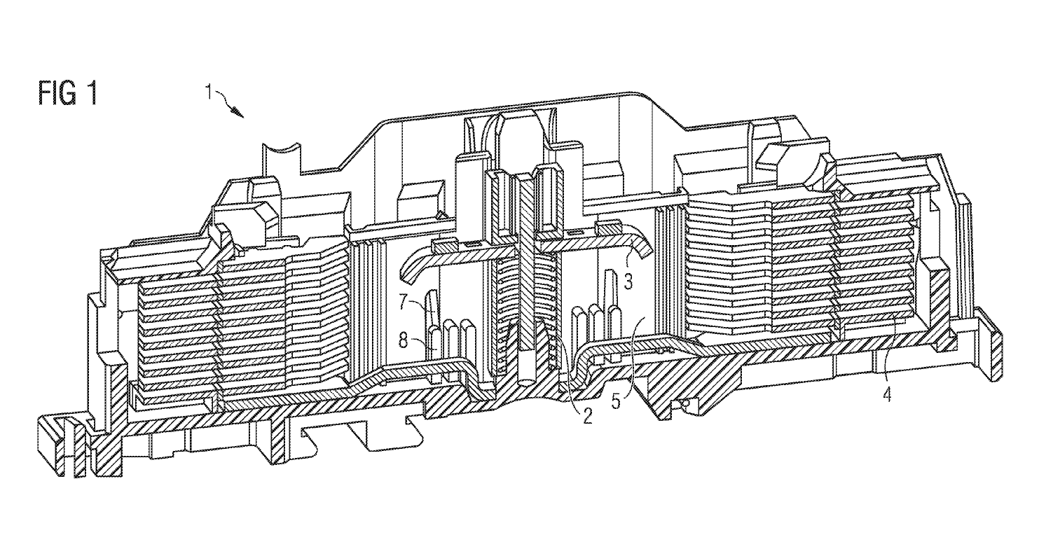

FIG. 1 shows schematically a sectional view of a switching device according to the invention with an arc quenching chamber and a sliding contact in which a movable contact element is guided;

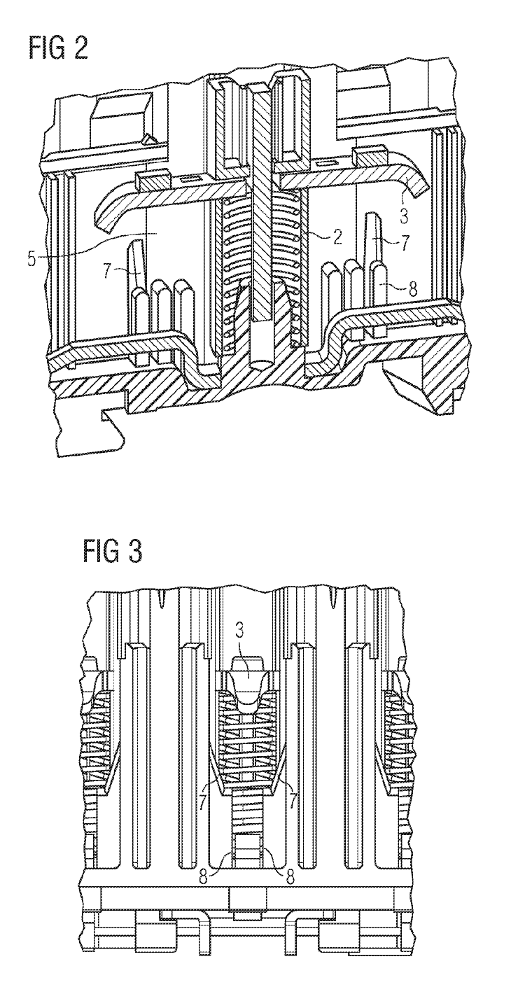

FIG. 2 shows schematically a sectional view of an enlarged illustration of a section from FIG. 1 with a sliding contact, movable contact element and centering structures according to the invention;

FIG. 3 shows schematically a sectional view of the centering structures according to the invention as a cross-section with a movable contact element;

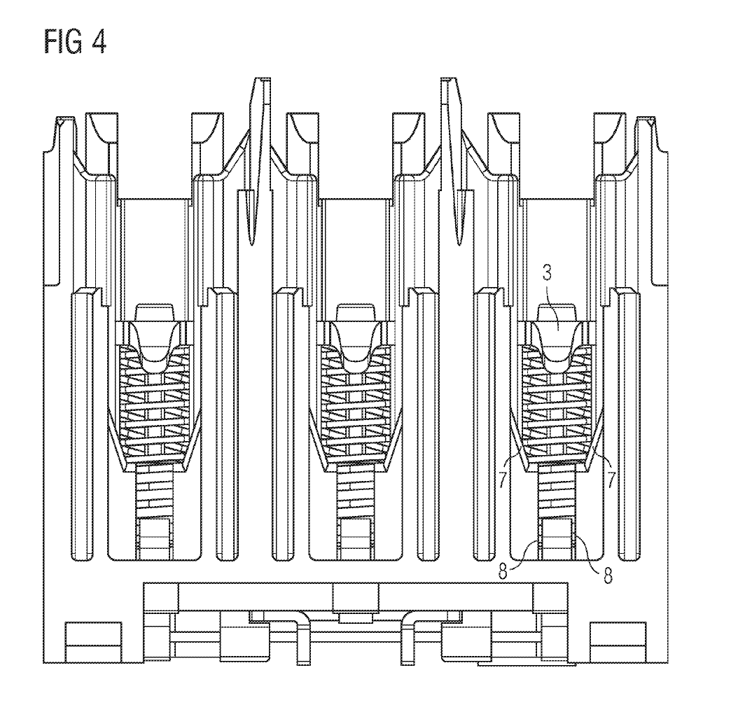

FIG. 4 shows schematically a sectional view of the centering structures according to the invention as a cross-section with the movable contact element in the on position;

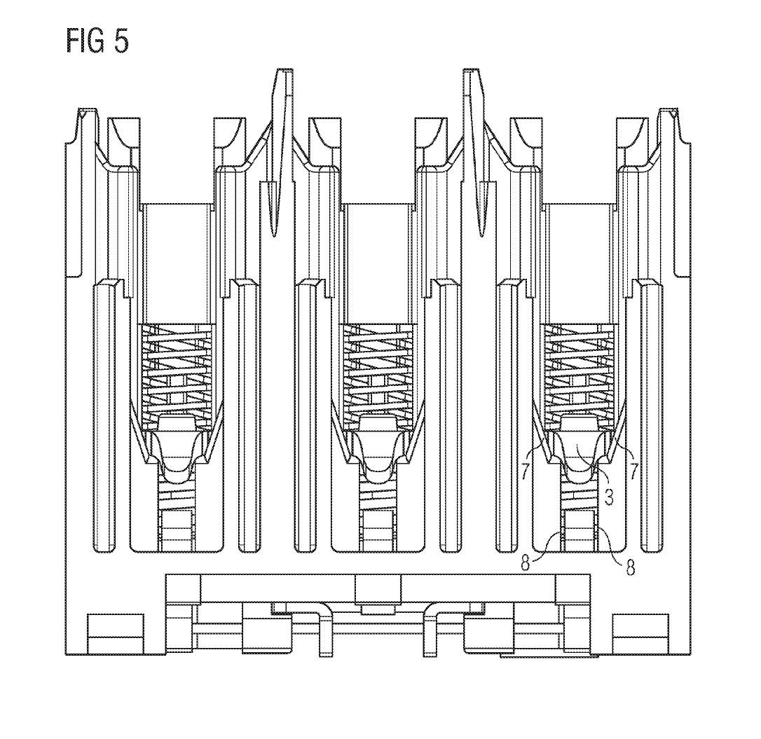

FIG. 5 shows schematically a sectional view of the centering structures according to the invention as a cross-section with the movable contact element in the tripped state during a short circuit.

FIG. 1 shows a section of a switching device, in particular of a power switch with an arc quenching chamber 1, in which a sliding contact 2 is arranged, in which a movable contact element 3 is guided. To the side, next to the movable contact element 3, both to the right and to the left, arc quenching baffle packages 4 are arranged, formed of arc quenching baffles arranged in parallel above one another. On a housing wall 5 of the arc quenching chamber 1, centering structures 7 according to the invention are arranged in the region of the movable contact element 3.

These centering structures 7 are preferably fabricated as one piece with the housing wall 5 of the arc quenching chamber, meaning that the centering structures 7 are not formed as an additional part on the housing wall 5, but are injection-molded together with the housing wall 5 in one process step. For that reason the centering structures 7 are preferably made of plastic. Preferably the centering structures 7 according to the invention are arranged on the housing wall 5 of the arc quenching chamber 1 parallel to one another and at a distance from one another.

Preferably a second set of centering structures 7 is arranged on a second housing wall of the arc quenching chamber 1 located opposite to a first set of centering structures 7 on the housing wall of the arc quenching chamber 1, so that the movable contact element 3 is positioned between two sets of centering structures.

The centering structures 7 according to the invention are preferably arranged to the side next to the sliding contact 2, that is to the right and left of the sliding contact 2.

In FIG. 2 the region around the sliding contact 2, that is the region to the left and right of the sliding contact 2, is illustrated. The positioning of the centering structures 7 according to the invention, which are arranged to the left and right of the sliding contact 2, can be seen from FIG. 2.

FIG. 3 shows the two regions of the centering structures 7 according to the invention as a cross-section from the side. When tripped, the movable contact element 3 is first accepted by the centering structure 7 and then strikes against the impact dome 8.

The position of the movable contact element when in the switched-on state can be seen in FIG. 4. FIG. 5 shows the position of the movable contact element 3 in the tripped state during a short circuit.

As a result of the centering structures according to the invention presented here, the bridge always meets the impact dome symmetrically, and jamming is avoided. It is also the case that, due to the centering structures according to the invention, the bridge is aligned centrally during a movement process, as a result of which, when in its off position, it always is at an adequate distance from the chamber walls. Melting inside the switching chamber is thus prevented.

1-7. (canceled)

8. A switching device, comprising:
an arc quenching chamber having housing walls;
a sliding contact in the arc quenching chamber;
a movable contact element arranged in the sliding contact for guiding movement of the movable contact element from an untripped position to a tripped position; and
a plurality of centering structures arranged on the housing walls of the arc quenching chamber for guiding movement of the movable contact element from its untripped position to its tripped position.

9. The switching device of claim 8, wherein the centering structures are unitarily fabricated as a single piece with the housing walls of the arc quenching chamber.

10. The switching device of claim 8, wherein the centering structures are formed of plastic.

11. The switching device of claim 8, wherein the plural centering structures are arranged in parallel and spaced apart relation to one another.

12. The switching device of claim 8, wherein the plural centering structures comprise a first set of centering structures and a second set of centering structures, and wherein the first set of centering structures is arranged on a first housing wall of the arc quenching chamber and the second set of centering structures is arranged on a second housing wall of the arc quenching chamber that is opposite the first housing wall so that the movable contact element is positioned between the first and second sets of centering structures.

13. The switching device of claim 8, wherein the centering structures are arranged on sides of and adjacent to the sliding contact.

14. The switching device of claim 8, wherein the switching device comprises a power switch.
